(19) United States
(12) Patent Application Publication
(10) Pub. No.: US 2013/0192491 A1
(43) Pub. Date: Aug. 1, 2013

(54) MODIFIED POLYHEDRAL POLYSILOXANE, COMPOSITION CONTAINING THE MODIFIED POLYHEDRAL POLYSILOXANE, AND CURED PRODUCT OBTAINED BY CURING THE COMPOSITION

(71) Applicant: Kaneka Corporation, Osaka (JP)

(72) Inventors: Yoshitaka Nishiyama, Settsu-shi (JP); Masahito Ide, Settsu-shi (JP); Takao Manabe, Settsu-shi (JP); Hiroyuki Tanaka, Settsu-shi (JP)

(73) Assignee: KANEKA CORPORATION, Osaka (JP)

(21) Appl. No.: 13/796,186

(22) Filed: Mar. 12, 2013

(30) Foreign Application Priority Data
Feb. 8, 2011 (JP) 2011-024743
Feb. 7, 2012 (JP) 2012-024423

(51) Int. Cl. C09D 4/00

(52) U.S. Cl. CPC C09D 4/00
USPC 106/287.15; 556/460; 556/456

(57) ABSTRACT

A modified polyhedral polysiloxane obtained by hydrosilylation of an alkenyl group-containing polyhedral polysiloxane compound (a), a hydrosilyl group-containing compound (b), and a cyclic olefin compound (c) having one carbon-carbon double bond in its molecule.

### TECHNICAL FIELD

The present invention relates to a polysiloxane composition that has high heat resistance and high light resistance, is excellent in gas-barrier properties, hot and cold impact resistance, and light extraction efficiency, and exhibits excellent handleability when used to encapsulate an optical semiconductor device; an encapsulant containing the composition; and an optical device.

### BACKGROUND ARTS

Polysiloxane compositions are used in various industries because of their excellence in heat resistance, cold resistance, weather resistance, light resistance, chemical stability, electrical characteristics, flame retardancy, water resistance, transparency, colorability, anti-adhesive properties, and anti-corrosive properties. In particular, compositions containing polyhedral polysiloxanes are known to have greater properties attributed to the unique chemical structures of the polyhedral polysiloxanes, such as greater heat resistance, greater light resistance, greater chemical stability, and much lower dielectric properties.

Applications of polyhedral polysiloxanes have been proposed, and some of them are intended for encapsulants for optical semiconductor devices. For example, JP-A 2008-163260 discloses a polyhedral polysiloxane composition containing a polyhedral polysiloxane resin having at least two oxetanyl groups, an aliphatic hydrocarbon having at least one epoxy group, and a cation polymerization initiator. This composition has a high refractive index and high light extraction efficiency, but has problems attributed to the oxetanyl and epoxy groups, such as low heat resistance and low light resistance.

Additionally, despite the above excellent features, polysiloxane compositions generally have a problem of low gas-barrier properties. Because of this problematic feature, these compositions, when used as optical semiconductor device encapsulants, may allow sulfides to turn lead frames black. In order to deal with this problem, for example, JP-A 2009-206124 discloses a pre-coating treatment of a metal member with an acrylic resin having high gas-barrier properties. This technique, however, is problematic in terms of productivity because it requires extra steps, such as encapsulation with a silicone resin, after the coating treatment with an acrylic resin.

In the field of optical semiconductor device encapsulants, the use of encapsulants containing a yellow fluorescent substance for blue light emitting devices is a common strategy to produce white light, and the use of encapsulants containing green and red fluorescent substances for blue light emitting devices is a common strategy to further increase color rendition. When these encapsulants have low viscosity, the fluorescent substances may settle during the handling of the encapsulants to cause a problem of non-uniform light colors. Thus, although excellent mold processability, transparency, heat resistance, light resistance, and adhesion are achieved, for example, by WO 2008/010545 which discloses a composition containing a modified polyhedral polysiloxane, there is still room for further improvement in terms of composition viscosity.

Against the above background, there is a need to develop materials that have high heat resistance and high light resistance, are excellent in hot and cold impact resistance, gas-barrier properties, and light extraction efficiency, and exhibit excellent handleability when used to encapsulate an optical semiconductor device.

### SUMMARY OF INVENTION

An object of the present invention is to provide a polysiloxane composition that has high heat resistance and high light resistance, is excellent in gas-barrier properties, hot and cold impact resistance, and light extraction efficiency, and exhibits excellent handleability when used to encapsulate an optical semiconductor device; an encapsulant containing the composition; and an optical device.

As a result of intensive studies, the present inventors found that the above-mentioned problems can be solved by a modified polyhedral polysiloxane obtained by hydrosilylation of an alkenyl group-containing polyhedral polysiloxane compound (a), a hydrosilyl group-containing compound (b), and a cyclic olefin compound (c) having one carbon-carbon double bond in its molecule. Thus, the present invention was completed.

Specifically, the present invention relates to a modified polyhedral polysiloxane obtained by hydrosilylation of an alkenyl group-containing polyhedral polysiloxane compound (a), a hydrosilyl group-containing compound (b), and a cyclic olefin compound (c) having one carbon-carbon double bond in its molecule.

Preferably, the cyclic olefin compound (c) has a weight average molecular weight of less than 1000.

Preferably, the modified polyhedral polysiloxane is in a liquid form at 20° C.

Preferably, the hydrosilyl group-containing compound (b) is a cyclic siloxane having a hydrosilyl group and/or a straight-chain siloxane having a hydrosilyl group.

Preferably, the alkenyl group-containing polyhedral polysiloxane compound (a) contains siloxane units represented by the formula:

[AR¹₂SiO—SiO_{3/2}]ₐ[R²₃SiO—SiO_{3/2}]_{b}

(wherein a+b is an integer of 6 to 24, provided that a is an integer of 1 or larger, and b is an integer of 0 or 1 or larger; A is alkenyl; R¹ is alkyl or aryl; R² is hydrogen, alkyl, aryl or a group bonded to another polyhedral polysiloxane.)

Preferably, the modified polyhedral polysiloxane contains siloxane units represented by the formula:

[XR³₂SiO—SiO_{3/2}]ₐ[R⁴₃SiO—SiO_{3/2}]_{b}

[wherein a+b is an integer of 6 to 24, provided that a is an integer of 1 or larger, and b is an integer of 0 or 1 or larger; R³ is alkyl or aryl; R⁴ is alkenyl, hydrogen, alkyl, aryl, or a group bonded to another polyhedral polysiloxane; and X is represented by the following formula (1) or (2), and in the case where multiple Xs are present, the Xs represented by the formula (1) or (2) may be the same or different, or the Xs may include both a structure represented by the formula (1) and a structure represented by the formula (2):

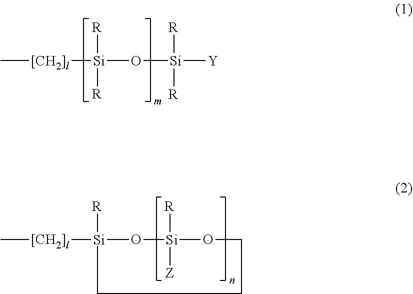

{wherein l is an integer of 2 or larger; m is an integer of 0 or larger; n is an integer of 2 or larger; Y is hydrogen, alkenyl, alkyl, aryl, or a moiety bonded to a polyhedral polysiloxane via an alkylene chain, and Ys may be the same or different from one another; Z is hydrogen, alkenyl, alkyl, aryl, or a moiety bonded to a polyhedral polysiloxane via an alkylene chain, and Zs may be the same or different from one another; at least one of Ys and Zs is hydrogen, and at least one of Ys and Zs has a structure represented by the formula (3):

—[CH₂]ₗ—R⁵ (3)

(wherein l is an integer of 0 or larger; and R⁵ is a group containing a cyclic structure having a carbon skeleton); and R is alkyl or aryl.}]

The present invention also relates to a polysiloxane composition containing the modified polyhedral polysiloxane of the present invention.

Preferably, the polysiloxane composition further contains a polysiloxane having at least two alkenyl groups in its molecule.

Preferably, the polysiloxane having at least two alkenyl groups in its molecule has at least one aryl group.

Preferably, the polysiloxane composition has a viscosity as measured at 23° C. of not less than 1 Pa·s.

Preferably, the polysiloxane composition further contains a hydrosilylation catalyst.

Preferably, the polysiloxane composition further contains a curing retardant.

The present invention further relates to a cured product obtained by curing the polysiloxane composition of the present invention.

The present invention further relates to an encapsulant containing the polysiloxane composition of the present invention.

Preferably, the encapsulant is an encapsulant for optical materials.

Preferably, the encapsulant is an encapsulant for high-brightness LEDs.

The present invention further relates to an optical device including the encapsulant of the present invention.

### DETAILED DESCRIPTION OF THE INVENTION

The following description is offered to illustrate the present invention in detail.

### <Modified Polyhedral Polysiloxane>

A modified polyhedral polysiloxane of the present invention is obtained by hydrosilylation of an alkenyl group-containing polyhedral polysiloxane compound (a), a hydrosilyl group-containing compound (b), and a cyclic olefin compound (c) having one carbon-carbon double bond in its molecule, preferably in the presence of a hydrosilylation catalyst.

Various methods can be used without particular limitation to produce the modified polyhedral polysiloxane of the present invention. Specifically, the component (a) and the component (b) may be reacted first followed by reaction with the component (c), or the component (c) and the component (b) may be reacted first followed by reaction with the component (a). Alternatively, the component (a) and the component (c) may be simultaneously reacted with the component (b). After each reaction step, volatile unreacted substances may be evaporated, for example, under reduced pressure and heating, to obtain the target product or an intermediate for the following step. In order to reduce the amount of the product of a reaction between the component (c) and the component (b) without the component (a), it is preferable that the component (a) and the component (b) are reacted first, unreacted component (b) is evaporated and then the component (c) is reacted.

Part of alkenyl groups derived from the component (a) used in the reaction may remain unreacted in the resulting modified polyhedral polysiloxane.

The amount of the hydrosilylation catalyst is not particularly limited, but is preferably 10⁻¹⁰ to 10⁻¹ mol, and more preferably 10⁻⁸ to 10⁻⁴ mol per 1 mol of all the alkenyl groups of the components (a) and (c) used in the reactions. Since some hydrosilylation catalysts absorb light with short wavelengths, the use of the hydrosilylation catalyst in an amount of more than 10⁻¹ mol can be a cause of discoloration. Additionally, cured products to be obtained may have reduced light resistance or may be porous. The use thereof in an amount of less than 10⁻¹⁰ mol may not allow the reactions to proceed, and thus the target product may not be provided.

The reaction temperature of the hydrosilylation reaction is preferably 30 to 400° C., more preferably 40 to 250° C., and particularly preferably 45 to 140° C. At temperatures of lower than 30° C., the reactions may not proceed to a sufficient extent, and at temperatures of higher than 400° C., gelation may occur, which leads to poor handleability.

The modified polyhedral polysiloxane obtained in the manner described above certainly has compatibility with various compounds, in particular, siloxane compounds, and additionally can react with various alkenyl group-containing compounds because the hydrosilyl group is incorporated in the molecule. For example, in the case where a polysiloxane composition containing the modified polyhedral polysiloxane is used as an encapsulant, a later-described polysiloxane having at least two alkenyl groups in its molecule is also contained, if necessary, and the composition is cured by reacting the modified polyhedral polysiloxane.

The modified polyhedral polysiloxane of the present invention can be prepared as a liquid at 20° C. The liquid form is preferable because it is easy to handle the modified polyhedral polysiloxane.

Preferably, the modified polyhedral polysiloxane of the present invention contains siloxane units represented by the formula:

[XR³₂SiO—SiO_{3/2}]ₐ[R⁴₃SiO—SiO_{3/2}]_{b}

[wherein a+b is an integer of 6 to 24, provided that a is an integer of 1 or larger, and b is an integer of 0 or 1 or larger; R³ is alkyl or aryl; R⁴ is alkenyl, hydrogen, alkyl, aryl, or a group bonded to another polyhedral polysiloxane; and X is represented by the following formula (1) or (2), and in the case where multiple Xs are present, the Xs represented by the formula (1) or (2) may be the same or different, or the Xs may include both a structure represented by the formula (1) and a structure represented by the formula (2):

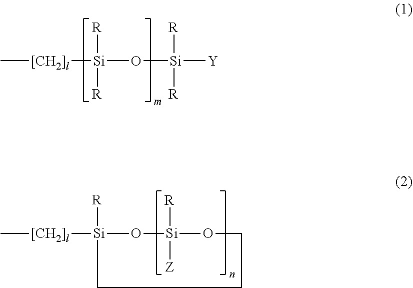

{wherein l is an integer of 2 or larger; m is an integer of 0 or larger; n is an integer of 2 or larger; Y is hydrogen, alkenyl, alkyl, aryl, or a moiety bonded to a polyhedral polysiloxane via an alkylene chain, and Ys may be the same or different from one another; Z is hydrogen, alkenyl, alkyl, aryl, or a moiety bonded to a polyhedral polysiloxane via an alkylene chain, and Zs may be the same or different from one another; at least one of Ys and Zs is hydrogen, and at least one of Ys and Zs has a structure represented by the formula (3):

—[CH₂]ₗ—R⁵ (3)

(wherein l is an integer of 0 or larger; and is a group containing a cyclic structure having a carbon skeleton); and R is alkyl or aryl.}]

The viscosity of the modified polyhedral polysiloxane can be controlled by adjusting the amounts of the components (a) to (c), the order, period, and temperature of the reactions, and other factors. The viscosity of the later-described polysiloxane composition can also be controlled by controlling the viscosity of the modified polyhedral polysiloxane. The viscosity of the modified polyhedral polysiloxane is not particularly limited. In the case where the modified polyhedral polysiloxane is in liquid form at 20° C., the viscosity at 20° C. is preferably 0.01 Pa·s to 300 Pa·s, and more preferably 1 Pa·s to 100 Pa·s. If the viscosity is less than 0.01 Pa·s, the later-described polysiloxane composition may have low viscosity, and may cause additives such as fluorescent substances to settle instead of allowing them to be dispersed. On the other hand, if the viscosity is higher than 300 Pa·s, the handleability may be poor.

The modified polyhedral polysiloxane preferably contains at least three hydrosilyl groups in its molecule, both in terms of the properties such as heat resistance and light resistance and the hardness and strength of cured products to be obtained therefrom.

<Alkenyl Group-Containing Polyhedral Polysiloxane Compound (a)>

The alkenyl group-containing polyhedral polysiloxane compound (a) used in the present invention is not particularly limited, provided that it is a polyhedral polysiloxane compound having an alkenyl group in its molecule.

Preferred examples include compounds containing siloxane units represented by the formula:

[R⁶SiO_{3/2}]ₓ[R⁷SiO_{3/2}]_{y}

(wherein x+y is an integer of 6 to 24, provided that x is an integer of 1 or larger, and y is an integer of 0 or 1 or larger; R⁶ is alkenyl or a group containing an alkenyl group; and R⁷ is any organic group or a group bonded to another polyhedral polysiloxane.)

Other preferred examples include compounds containing siloxane units represented by the formula:

[AR¹₂SiO—SiO_{3/2}]ₐ[R²₃SiO—SiO_{3/2}]_{b}

(wherein a+b is an integer of 6 to 24, provided that a is an integer of 1 or larger, and b is an integer of 0 or 1 or larger; A is alkenyl; R¹ is alkyl or aryl; and R² is hydrogen, alkyl, aryl or a group bonded to another polyhedral polysiloxane.)

Preferred examples of alkenyl groups include vinyl, allyl, butenyl, and hexenyl. In terms of the heat resistance and light resistance, vinyl is preferable.

R¹ is alkyl or aryl. Specific examples of alkyl groups include methyl, ethyl, propyl, butyl, cyclohexyl, and cyclopentyl, and specific examples of aryl groups include phenyl and tolyl. R¹ is preferably methyl in terms of the heat resistance and light resistance.

R² is hydrogen, alkyl, aryl, or a group bonded to another polyhedral polysiloxane. Specific examples of alkyl groups include methyl, ethyl, propyl, butyl, cyclohexyl, and cyclopentyl, and specific examples of aryl groups include phenyl and tolyl. R² is preferably methyl in terms of the heat resistance and light resistance.

The symbol a is not particularly limited, provided that it is an integer of 1 or larger. However, a is preferably 2 or larger, and more preferably 3 or larger in terms of handleability of the compound and physical properties of cured products to be obtained. Also, b is not particularly limited, provided that it is an integer of 0 or 1 or larger.

The sum of a and b (a+b) is an integer of 6 to 24, and is preferably 6 to 12, and more preferably 6 to 10 in terms of the stability of the compound and the stability of cured products to be obtained.

The component (a) can be synthesized by any methods without particular limitation, and known methods can be used. An example of synthesis methods is hydrolysis-condensation of a silane compound represented by the formula: R⁸SiX^{a}₃ (wherein R⁸ is R⁶ or R⁷ described above, and X^{a} is halogen or a hydrolyzable functional group such as an alkoxy group.) Another example of known synthesis methods is a method for synthesizing a polyhedral polysiloxane which involves synthesizing a trisilanol compound that contains three silanol groups in its molecule by hydrolysis of a compound represented by R⁸SiX^{a}₃, and reacting the synthesized trisilanol compound with a trifunctional silane compound that is the same as or different from the former to form a closed ring.

Still another example is hydrolysis-condensation of a tetraalkoxysilane such as tetraethoxysilane in the presence of a base such as a quaternary ammonium hydroxide. In this synthesis method, the hydrolysis-condensation of a tetraalkoxysilane produces a polyhedral silicate, and the resulting silicate is further reacted with a silylating agent such as an alkenyl group-containing silyl chloride, thereby providing a polyhedral polysiloxane in which Si atoms forming a polyhedral structure and an alkenyl group are bonded via siloxane bonds. The tetraalkoxysilane may be replaced by silica or a material containing silica such as rice husk to produce a polysiloxane having the same polyhedral structure.

<Hydrosilyl Group-Containing Compound (b)>

The hydrosilyl group-containing compound (b) used in the present invention is not particularly limited, provided that it contains at least one hydrosilyl group in its molecule. However, the compound (b) is preferably a hydrosilyl group-containing siloxane compound, and more preferably a cyclic siloxane having a hydrosilyl group and/or a straight-chain polysiloxane having a hydrosilyl group in terms of the transparency, heat resistance, and light resistance of the resulting modified polyhedral polysiloxane. In particular, a cyclic siloxane is preferable in terms of the gas-barrier properties.

The number of siloxane units of the cyclic siloxane having a hydrosilyl group and/or the straight-chain polysiloxane having a hydrosilyl group is not particularly limited, but is preferably at least 2. Additionally, the number is preferably at most 10. If it is larger than 10, gas-barrier properties of a cured product may deteriorate.

Examples of the straight-chain polysiloxane having a hydrosilyl group include copolymers containing dimethylsiloxane units, methylhydrogensiloxane units, and terminal trimethylsiloxy units; copolymers containing diphenylsiloxane units, methylhydrogensiloxane units, and terminal trimethylsiloxy units; copolymers containing methylphenylsiloxane units, methylhydrogensiloxane units, and terminal trimethylsiloxy units; dimethylhydrogensilyl group-terminated polydimethylsiloxanes; dimethylhydrogensilyl group-terminated polydiphenylsiloxanes; and dimethylhydrogensilyl group-terminated polymethylphenylsiloxanes.

In particular, in terms of the reactivity in modification, the heat and light resistance of cured products to be obtained, and the like, preferably dimethylhydrogensilyl group-terminated polysiloxanes, more preferably dimethylhydrogensilyl group-terminated polydimethylsiloxanes can be suitably used as the straight-chain polysiloxane having a hydrosilyl group. Specific preferred examples include tetramethyldisiloxane and hexamethyltrisiloxane.

Examples of the cyclic siloxane having a hydrosilyl group include monocyclic siloxanes such as 1,3,5,7-tetrahydrogen-1,3,5,7-tetramethylcyclotetrasiloxane, 1-propyl-3,5,7-trihydrogen-1,3,5,7-tetramethylcyclotetrasiloxane, 1,5-dihydrogen-3,7-dihexyl-1,3,5,7-tetramethylcyclotetrasiloxane, 1,3,5-trihydrogen-1,3,5-trimethylcyclotrisiloxane, 1,3,5,7,9-pentahydrogen-1,3,5,7,9-pentamethylcyclopentasiloxane, and 1,3,5,7,9,11-hexahydrogen-1,3,5,7,9,11-hexamethylcyclohexasiloxane. Specifically, for example, 1,3,5,7-tetrahydrogen-1,3,5,7-tetramethylcyclotetrasiloxane can be suitably used in terms of the industrial availability and reactivity, the heat resistance, light resistance, and strength of cured products to be obtained, and the like.

Any of these hydrosilyl group-containing compounds (b) may be used alone, or two or more of these may be used in combination.

The amount of the hydrosilyl group-containing compound (b) is preferably determined such that the number of hydrogen atoms directly bonded to Si atoms of the compound (b) is larger than 1 but not larger than 30 per alkenyl group of the alkenyl group-containing polyhedral polysiloxane compound (a). The number of hydrogen atoms is more preferably 2.5 to 20 although it differs among compounds. If the number is less than 1, the cross linking reaction causes gelation, resulting in a modified polyhedral polysiloxane with low handleability. On the other hand, if the number is more than 30, the physical properties of cured products obtained from the modified polyhedral polysiloxane may be adversely affected. Additionally, since too much component (b) is added, it is preferable to remove unreacted component (b), for example, under reduced pressure and heating.

### <Cyclic Olefin Compound (c) Having One Carbon-Carbon Double Bond in its Molecule>

The cyclic olefin compound (c) having one carbon-carbon double bond in its molecule used in the present invention is hydrosilylated by the hydrosilyl group of the hydrosilyl group-containing compound (b). The use of the component (c) provides an encapsulant that exhibits reduced elasticity and enhanced hot and cold impact resistance after curing. Additionally, the use of the component (c) improves the gas-barrier properties and light extraction efficiency of the encapsulant to be obtained.

The component (c) used in the present invention is not particularly limited, provided that it is a cyclic olefin compound having one carbon-carbon double bond in its molecule, and the carbon-carbon double bond may be any of vinylene, vinylidene, and alkenyl groups. Preferred examples of the alkenyl groups include vinyl, allyl, butenyl, and hexenyl. In particular, vinyl is preferable in terms of the heat resistance and light resistance.

The weight average molecular weight of the component (c) used in the present invention is preferably less than 1000 in terms of the reactivity with the component (b). Examples of such cyclic olefin compounds include aliphatic cyclic olefin compounds and substituted aliphatic cyclic olefin compounds.

Specific examples of the aliphatic cyclic olefin compounds include cyclohexene, cycloheptene, cyclooctene, vinylcyclohexane, vinylcycloheptane, vinylcyclooctane, allylcyclohexane, allylcycloheptane, allylcyclooctane, and methylenecyclohexane.

Specific examples of the substituted aliphatic cyclic olefin compounds include norbornene, 1-methylnorbornene, 2-methylnorbornene, 7-methylnorbornene, 2-vinylnorbornane, 7-vinylnorbornane, 2-allylnorbornane, 7-allylnorbornane, 2-methylenenorbornane, 7-methylenenorbornane, camphene, 6-methyl-5-vinyl-bicyclo[2.2.1]-heptane, 3-methyl-2-methylene-bicyclo[2.2.1]-heptane, α-pinene, β-pinene, 6,6-dimethyl-bicyclo[3.1.1]-2-heptaene, 2-vinyladamantane, and 2-methyleneadamantane.

In particular, in terms of the availability, preferred examples include cyclohexene, vinylcyclohexane, norbornene, camphene, and pinenes.

Any of these cyclic olefin compounds (C) having one carbon-carbon double bond in its molecule may be used alone, or two or more of them may be used in combination.

The amount of the cyclic olefin compound (c) having one carbon-carbon double bond in its molecule is preferably determined such that the number of carbon-carbon double bonds of the component (c) is 0.01 to 0.5 per hydrosilyl group of the hydrosilyl group-containing compound (b). The number of carbon-carbon double bonds is more preferably 0.1 to 0.4. If the number is less than 0.01, cured products to be obtained may have reduced hot and cold impact resistance, and if the number is more than 0.5, an encapsulant that will not sufficiently cure may be obtained.

### <Polysiloxane Composition>

A polysiloxane composition of the present invention contains the modified polyhedral polysiloxane of the present invention.

The polysiloxane composition of the present invention can be prepared as a liquid resin composition. The liquid resin composition is preferable because it can be readily poured into or applied to a mold, package, substrate or the like and cured into a molded product suited for the intended use.

The viscosity of the polysiloxane composition of the present invention is not particularly limited, but is preferably 1 Pa·s to 300 Pa·s at 23° C., and more preferably 2 Pa·s to 100 Pa·s at 23° C. If the viscosity is less than 1 Pa·s, additives such as fluorescent substances may settle instead of being dispersed, and if the viscosity is higher than 300 Pa·s, the handleability may be poor.

The polysiloxane composition can be produced by any method without particular limitation, and specifically can be produced by adding later-described materials to the modified polyhedral polysiloxane as desired, and homogeneously mixing them with a kneading machine such as a roll mill, Banbury mixer, or kneader, or with a planetary stirring and defoaming device. Optionally, a heating treatment may be further performed.

### <Polysiloxane Having at Least Two Alkenyl Groups in its Molecule>

Preferably, the polysiloxane composition further contains a polysiloxane having at least two alkenyl groups in its molecule. The number of siloxane units of the polysiloxane having at least two alkenyl groups in its molecule is not particularly limited, but is preferably not less than 2 and not more than 30, and more preferably 2 to 10. If the number is less than 2, the polysiloxane tends to evaporate from the composition, and the physical properties of the composition after curing may not be at desired levels. On the other hand, if the number is more than 30, the polysiloxane composition may have reduced gas-barrier properties.

The polysiloxane having at least two alkenyl groups in its molecule preferably has an aryl group in terms of the gas-barrier properties. In such an aryl group-containing polysiloxane having at least two alkenyl groups in its molecule, the aryl group is preferably bonded directly to a Si atom in terms of the heat resistance and light resistance. Additionally, the aryl group may be located either in a side chain or at a terminal of the molecule. The molecular structure of the aryl group-containing polysiloxane is not limited, and may be, for example, a straight-chain structure, a branched-chain structure, a partially branched straight-chain structure, or a cyclic structure.

Examples of the aryl group include phenyl, naphthyl, 2-methylphenyl, 3-methylphenyl, 4-methylphenyl, 2-ethylphenyl, 3-ethylphenyl, 4-ethylphenyl, 2-propylphenyl, 3-propylphenyl, 4-propylphenyl, 3-isopropylphenyl, 4-isopropylphenyl, 2-butylphenyl, 3-butylphenyl, 4-butylphenyl, 3-isobutylphenyl, 4-isobutylphenyl, 3-t-butylphenyl, 4-t-butylphenyl, 3-pentylphenyl, 4-pentylphenyl, 3-hexylphenyl, 4-hexylphenyl, 3-cyclohexylphenyl, 4-cyclohexylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2,3-diethylphenyl, 2,4-diethylphenyl, 2,5-diethylphenyl, 2,6-diethylphenyl, 3,4-diethylphenyl, 3,5-diethylphenyl, biphenyl, 2,3,4-trimethylphenyl, 2,3,5-trimethylphenyl, 2,4,5-trimethylphenyl, 3-epoxyphenyl, 4-epoxyphenyl, 3-glycidylphenyl, and 4-glycidylphenyl. In particular, in terms of the heat resistance and light resistance, phenyl is preferred. Any of these may be used alone, or two or more of these may be used in combination.

Preferred examples of the polysiloxane having at least two alkenyl groups in its molecule include straight-chain polysiloxanes having at least two alkenyl groups, polysiloxanes terminated with at least two alkenyl groups, and cyclic siloxanes having at least two alkenyl groups in terms of the heat resistance and light resistance.

Specific examples of the straight-chain polysiloxanes having at least two alkenyl groups include copolymers containing dimethylsiloxane units, methylvinylsiloxane units, and terminal trimethylsiloxy units; copolymers containing diphenylsiloxane units, methylvinylsiloxane units, and terminal trimethylsiloxy units; copolymers containing methylphenylsiloxane units, methylvinylsiloxane units, and terminal trimethylsiloxy units; dimethylvinylsilyl group-terminated polydimethylsiloxanes; dimethylvinylsilyl group-terminated polydiphenylsiloxanes; and dimethylvinylsilyl group-terminated polymethylphenylsiloxanes.

Specific examples of the polysiloxanes terminated with at least two alkenyl groups include dimethylvinylsilyl group-terminated polysiloxanes mentioned above; and polysiloxanes containing two or more dimethylvinylsiloxane units and at least one siloxane unit selected from the group consisting of SiO₂ unit, SiO_{3/2} unit, and SiO unit.

Examples of the cyclic siloxane compounds having at least two alkenyl groups include 1,3,5,7-tetravinyl-1,3,5,7-tetramethylcyclotetrasiloxane, 1,3,5,7-tetravinyl-1-phenyl-3,5,7-trimethylcyclotetrasiloxane, 1,3,5,7-tetravinyl-1,3-diphenyl-5,7-dimethylcyclotetrasiloxane, 1,3,5,7-tetravinyl-1,5-diphenyl-3,7-dimethylcyclotetrasiloxane, 1,3,5,7-tetravinyl-1,3,5-triphenyl-7-methylcyclotetrasiloxane, 1-phenyl-3,5,7-trivinyl-1,3,5,7-tetramethylcyclotetrasiloxane, 1,3-diphenyl-5,7-divinyl-1,3,5,7-tetramethylcyclotetrasiloxane, 1,3,5-trivinyl-1,3,5-trimethylcyclotrisiloxane, 1,3,5,7,9-pentavinyl-1,3,5,7,9-pentamethylcyclopentasiloxane, and 1,3,5,7,9,11-hexavinyl-1,3,5,7,9,11-hexamethylcyclohexasiloxane.

Any of these polysiloxanes having at least two alkenyl groups in its molecule may be used alone, or two or more of these may be used in combination.

The amount of the polysiloxane having at least two alkenyl groups in its molecule can be determined as desired, but is preferably determined such that the number of hydrogen atoms directly bonded to Si atoms of the modified polyhedral polysiloxane is 0.3 to 5 per alkenyl group. The number of hydrogen atoms is more preferably 0.5 to 3. If the number of hydrogen atoms is more than 5, the relative amount of alkenyl groups is too small, resulting in a higher probability of poor appearance such as pores. On the other hand, if the number is less than 0.3, the relative amount of alkenyl groups is too much, which may adversely affect the physical properties after curing.

### <Hydrosilylation Catalyst>

Preferably, the polysiloxane composition further contains a hydrosilylation catalyst. The hydrosilylation catalyst functions in synthesis of the modified polyhedral polysiloxane and curing of the composition containing the modified polyhedral polysiloxane.

In the case where the hydrosilylation catalyst is used in synthesis of the modified polyhedral polysiloxane, it is not necessary to add the hydrosilylation catalyst additionally for hydrosilylation of the modified polyhedral polysiloxane and the polysiloxane having at least two alkenyl groups in its molecule because the hydrosilylation catalyst is already present.

Any of generally known hydrosilylation catalysts can be used without particular limitation. Specific examples thereof include platinum-olefin complexes, chloroplatinic acid, elemental platinum, and carriers (such as alumina, silica, and carbon black) which carry solid platinum; platinum-vinylsiloxane complexes such as Ptₙ(ViMe₂SiOSiMe₂Vi)ₙ and Pt[(MeViSiO)₄]ₙ; platinum-phosphine complexes such as Pt(PPh₃)₄ and Pt(PBu₃)₄; platinum-phosphite complexes such as Pt[P(OPh)₃]₄ and Pt[P(OBu)₃]₄ in which Me represents methyl, Bu represents butyl, Vi represents vinyl, Ph represents phenyl, and n and m each represent an integer; and Pt(acac)₂. In addition, platinum-hydrocarbon complexes as disclosed in U.S. Pat. No. 3,159,601 and No. 3,159,662 by Ashby et al., and platinum alcoholate catalysts as disclosed in U.S. Pat. No. 3,220,972 by Lamoreaux et al. may also be mentioned.

Examples of catalysts other than platinum compounds include RhCl(PPh₃)₃, RhCl₃, Rh/Al₂O₃, RuCl₃, IrCl₃, FeCl₃, AlCl₃, PdCl₂.2H₂O, NiCl₂, and TiCl₄. These catalysts may be used alone, or two or more of these may be used in combination. In terms of catalytic activity, preferred are chloroplatinic acid, platinum-olefin complexes, platinum-vinylsiloxane complexes, Pt(acac)₂, and the like.

The amount of the hydrosilylation catalyst is not particularly limited, but is preferably at least 10⁻³ mol and more preferably at least 10⁻⁶ mol, and at most 10⁻² mol and more preferably at most 10⁻³ mol per hydrosilyl group in the polysiloxane composition from the viewpoint of achieving sufficient curability and reducing the cost of the curable composition.

### <Curing Retardant>

Preferably, the polysiloxane composition further contains a curing retardant. The curing retardant is an optional component that is used in order to improve the storage stability of the polysiloxane composition of the present invention or to control the reactivity of the hydrosilylation during the curing process. The curing retardant may be any one generally known to be used for addition-curable compositions that are cured in the presence of a hydrosilylation catalyst, and specific examples thereof include compounds containing an aliphatic unsaturated bond, organophosphorus compounds, organosulfur compounds, nitrogen-containing compounds, tin compounds, and organic peroxides. Any of these may be used alone, or two or more of these may be used in combination.

Specific examples of the compounds containing an aliphatic unsaturated bond include propargyl alcohols such as 3-hydroxy-3-methyl-1-butyne, 3-hydroxy-3-phenyl-1-butyne, 3,5-dimethyl-1-hexyne-3-ol, and 1-ethynyl-1-cyclohexanol; ene-yne compounds; and maleic anhydride and maleates such as dimethyl maleate.

Specific examples of the organophosphorus compounds include triorganophosphines, diorganophosphines, organophosphones, and triorganophosphites.

Specific examples of the organosulfur compounds include organomercaptans, diorganosulfides, hydrogen sulfide, benzothiazole, thiazole, and benzothiazole disulfide.

Specific examples of the nitrogen-containing compounds include N,N,N,N′-tetramethylethylenediamine, N,N-dimethylethylenediamine, N,N-diethylethylenediamine, N,N-dibutylethylenediamine, N,N-dibutyl-1,3-propanediamine, N,N-dimethyl-1,3-propanediamine, N,N,N′,N′-tetraethylethylenediamine, N,N-dibutyl-1,4-butanediamine, and 2,2′-bipyridine.

Specific examples of the tin compounds include stannous halide dihydrates and stannous carboxylate.

Specific examples of the organic peroxides include di-t-butyl peroxide, dicumyl peroxide, benzoyl peroxide, and t-butyl perbenzoate.

Among these, dimethyl maleate, 3,5-dimethyl-1-hexyne-3-ol, and 1-ethynyl-1-cyclohexanol may be mentioned as particularly preferred curing retardants.

The amount of the curing retardant is not particularly limited, and it preferably ranges from 10⁻¹ to 10³ mol, more preferably from 1 to 300 mol per 1 mol of the hydrosilylation catalyst. Any of these curing retardants may be used alone, or two or more of these may be used in combination.

### <Adhesion Promoter>

The polysiloxane composition of the present invention may optionally contain an adhesion promoter.

The adhesion promoter is an optional component that is used in order to enhance adhesion between the polysiloxane composition and a substrate. There is no limitation in selecting the adhesion promoter as long as it exerts such an effect, and preferred examples thereof include silane coupling agents.

The silane coupling agents are not particularly limited as long as they are compounds each of which contains at least one functional group reactive with an organic group, and at least one hydrolyzable silicon group in its molecule. The functional group reactive with an organic group is preferably at least one functional group selected from the group consisting of epoxy, methacrylic, acrylic, isocyanate, isocyanurate, vinyl, and carbamate, in terms of the handleability. In terms of the curability and adhesion, epoxy, methacrylic, and acrylic are particularly preferred. The hydrolyzable silicon group is preferably alkoxysilyl in terms of the handleability, and in particular, methoxysilyl and ethoxysilyl are preferable in terms of the reactivity.

Specific preferred examples of the silane coupling agents include alkoxysilanes having an epoxy functional group, such as 3-glycidoxypropyltrimethoxysilane, 3-glycidoxypropylmethyldimethoxysilane, 3-glycidoxypropyltriethoxysilane, 3-glycidoxypropylmethyldiethoxysilane, 2-(3,4-epoxycyclohexyl)ethyltrimethoxysilane, 2-(3,4-epoxycyclohexyl)ethylmethyldimethoxysilane, 2-(3,4-epoxycyclohexyl)ethyltriethoxysilane, and 2-(3,4-epoxycyclohexyl)ethylmethyldiethoxysilane; and alkoxysilanes having a methacrylic or acrylic group, such as 3-methacryloxypropyltrimethoxysilane, 3-methacryloxypropyltriethoxysilane, 3-acryloxypropyltrimethoxysilane, 3-acryloxypropyltriethoxysilane, methacryloxymethyltrimethoxysilane, methacryloxymethyltriethoxysilane, acryloxymethyltrimethoxysilane, and acryloxymethyltriethoxysilane. Any of these may be used alone, and two or more of these may be used in combination.

The amount of the silane coupling agent is preferably 0.05 to 30 parts by weight, and more preferably 0.1 to 10 parts by weight, for each 100 parts by weight of the polysiloxane composition. If the amount is less than 0.05 parts by weight, the effect of improving adhesion may not be obtained. If the amount is more than 30 parts by weight, the physical properties of cured products may be adversely affected.

Additionally, a known adhesion enhancer may be used in order to enhance the effect of the adhesion promoter. Examples of the adhesion enhancer include, but are not limited to, epoxy-containing compounds, epoxy resins, boronic acid ester compounds, organoaluminum compounds, and organotitanium compounds.

### <Inorganic Filler>

The polysiloxane composition of the present invention may optionally contain an inorganic filler.

The use of an inorganic filler can improve the physical properties of molded products to be obtained, in terms of the strength, hardness, elastic modulus, coefficient of thermal expansion, thermal conductivity, heat dissipation, electrical characteristics, light reflectance, flame retardance, fire resistance, gas-barrier properties, and the like.

The inorganic filler is not particularly limited as long as it is an inorganic material or a compound that contains an inorganic material. Specific examples thereof include silica-based inorganic fillers (e.g. quartz, fumed silica, precipitated silica, silicic anhydride, molten silica, crystalline silica, ultrafine amorphous silica), alumina, zircon, iron oxide, zinc oxide, titanium oxide, silicon nitride, boron nitride, aluminum nitride, silicon carbide, glass fiber, glass flakes, alumina fiber, carbon fiber, mica, black lead, carbon black, ferrite, graphite, diatomaceous earth, white clay, clay, talc, aluminum hydroxide, calcium carbonate, manganese carbonate, magnesium carbonate, barium sulfate, potassium titanate, calcium silicate, inorganic balloons, and silver powder.

Any of these may be used alone, or two or more of these may be used in combination.

The inorganic filler may appropriately be surface-treated. Examples of the surface treatment include, but are not particularly limited to, alkylation treatment, trimethylsilylation treatment, silicone treatment, and treatment by a silane coupling agent.

Inorganic fillers having various shapes such as crushed, flake, spherical, and rod shapes may be used. The average particle size and particle size distribution of the inorganic filler are not particularly limited, and the preferred average particle size ranges from 0.005 to 50 μm, more preferably from 0.01 to 20 μm in terms of the gas-barrier properties. The BET specific surface area thereof is not particularly limited either, but is preferably not less than 70 m²/g, more preferably not less than 100 m²/g, and particularly preferably not less than 200 m²/g in terms of the gas-barrier properties.

The amount of the inorganic filler is not particularly limited, but is preferably 1 to 1000 parts by weight, more preferably 3 to 500 parts by weight, and still more preferably 5 to 300 parts by weight relative to 100 parts by weight of the polysiloxane composition. If the amount is more than 1000 parts by weight, an encapsulant with poor flowability may be obtained. If the amount is less than 1 part by weight, desired physical properties may not be achieved.

The order of mixing of the inorganic filler is not particularly limited. In the case where the polysiloxane having at least two alkenyl groups in its molecule is used, a preferred order in terms of better storage stability is mixing the inorganic filler with the polysiloxane, followed by mixing the modified polyhedral polysiloxane with the resulting mixture. Another preferred order is mixing the inorganic filler with a mixture of the modified polyhedral polysiloxane and the polysiloxane having at least two alkenyl groups in its molecule because the reaction components, namely, the modified polyhedral polysiloxane and the polysiloxane having at least two alkenyl groups in its molecule are well mixed so that it is likely to obtain stable molded products.

The means for mixing the inorganic filler is not particularly limited, and specific examples thereof include stirring apparatus such as two-roll or three-roll mills, planetary stirring and defoaming apparatus, homogenizers, dissolvers, and planetary mixers, and melt-kneaders such as plastomill. The inorganic filler may be mixed at ordinary temperature or under heated conditions, and may be mixed at ordinary pressure or under vacuum conditions. If the temperature is too high when inorganic filler is mixed, the composition may be cured before molding.

Also, the polysiloxane composition of the present invention may optionally contain various additives (e.g. fluorescent substances, colorants, and heat-resistance improving agents), reaction control agents, mold release agents, and dispersants for fillers. These optional components are preferably used in minimum amounts so that they do not impair the effects of the present invention.

Examples of the dispersants for fillers include diphenylsilanediol, various alkoxysilanes, carbon-functional silanes, and silanol group-containing siloxanes with low molecular weights.

### <Encapsulant>

An encapsulant of the present invention contains the polysiloxane composition of the present invention that contains the modified polyhedral polysiloxane. The polysiloxane composition optionally contains a polysiloxane having at least two alkenyl groups in its molecule, a hydrosilylation catalyst, a curing retardant, and the like as described above.

The encapsulant of the present invention can be used as an encapsulant for optical materials because of its excellence in heat resistance, light resistance, gas-barrier properties, light extraction efficiency, and handleability. The term “optical material” herein means general materials used in applications in which they are required to allow visible light, infrared light, ultraviolet light, X rays, laser beams, or the like to pass therethrough. In particular, in the case where the encapsulant of the present invention is used as an encapsulant for LEDs, high-brightness LEDs can be obtained because it improves the light extraction efficiency of light emitted out. The optical device of the present invention is produced using the encapsulant of the present invention.

### <Cured Product>

A cured product of the present invention can be formed by curing the polysiloxane composition of the present invention.

For example, a cured product can be obtained as a result of hydrosilylation of the hydrosilyl groups of the modified polyhedral polysiloxane of the present invention and the alkenyl groups of the polysiloxane having at least two alkenyl groups in its molecule. The hydrosilylation is preferably carried out in the presence of a hydrosilylation catalyst. Examples of hydrosilylation catalysts usable in this reaction include those described above.

In the case where the polysiloxane composition is cured by heating, the temperature is preferably elevated to 30 to 400° C., and more preferably 50 to 250° C. At temperatures of higher than 400° C., a cured product with poor appearance may be obtained, and at temperatures of lower than 30° C., the curing may not proceed to a sufficient extent. The composition may be cured under two- or multiple-stage temperature conditions. A specific example thereof is stepwise elevation of the curing temperature, for example, to 70° C., then to 120° C., and then to 150° C., which is preferable because satisfactory cured products can be produced.

The curing period can be appropriately determined depending on the curing temperature, the amount of the hydrosilylation catalyst, and the amount of reactive groups, as well as the combination of other components in the composition. For example, one minute to 12 hours is mentioned. Curing for ten minutes to eight hours may be preferable to obtain a good cured product.

A cured product may be obtained as a molded product. The molding method may be any method such as extrusion molding, compression molding, blow molding, calendar molding, vacuum molding, foam molding, injection molding, liquid injection molding, and cast molding.

Specific examples of applications of these cured products include, in the liquid crystal display field, peripheral materials for liquid crystal display devices such as substrate materials, light guide plates, prism sheets, polarizing plates, retardation films, viewing angle compensation films, adhesives, color filters, and films for LCDs such as polarizer protective films and passivation films. Other examples include materials for PDPs (plasma display panels), such as encapsulants, anti-reflection films, optical compensation films, housing materials, protection films for front glass, alternative materials for front glass, adhesives, color filters, and passivation films; materials for LED display devices, such as molding materials for LED elements, protection films for front glass, alternative materials for front glass, adhesives, color filters, and passivation films; materials for plasma address liquid crystal displays, such as substrate materials, light guide plates, prism sheets, polarizing plates, retardation films, viewing angle compensation films, adhesives, color filters, polarizer protective films, and passivation films; materials for organic EL displays, such as protection films for front glass, alternative materials for front glass, color filters, adhesives, and passivation films; and materials for field emission displays (FEDs), such as various film substrates, protection films for front glass, alternative materials for front glass, adhesives, color filters, and passivation films.

Specific examples in the optical recording field include materials for VDs (video disks), CD/CD-ROMs, CD-R/RWs, DVD-R/DVD-RAMS, MO/MDs, PDs (phase-change disks), and optical cards, such as disk substrate materials, pickup lenses, protective films, encapsulants, and adhesives. More specifically, there may be mentioned materials for optical pickups of next-generation DVDs and the like, such as pickup lenses, collimator lenses, objective lenses, sensor lenses, protective films, encapsulants for elements, encapsulants for sensors, gratings, adhesives, prisms, wave plates, correcting plates, splitters, holograms, and mirrors.

Examples of the applications in the optical equipment field include materials for still cameras, such as materials for lenses, prism finders, target prisms, finder covers, and light sensors; materials for video cameras, such as lenses and finders; materials for projection televisions, such as projector lenses, protective films, encapsulants, and adhesives; and materials for optical sensing equipment, such as materials for lenses, encapsulants, adhesives, and films.

Examples of the applications in the optical components field include peripheral materials for optical switches in optical communication systems, such as fiber materials, lenses, waveguides, and encapsulants and adhesives for elements; peripheral materials for optical connectors, such as optical fiber materials, ferrules, encapsulants, and adhesives; materials for passive optical components and optical circuit components, such as lenses, waveguides, and encapsulants and adhesives for LED elements; and peripheral materials for opto-electronic integrated circuits (OEICs), such as substrate materials, fiber materials, and encapsulants and adhesives for elements.

Examples of the applications in the optical fiber field include materials for decoration displays, such as lighting and light guides; sensors, indications, signs and the like for industrial use; and optical fibers for communications infrastructures and for home networking of digital devices.

Examples of the applications as peripheral materials for semiconductor integrated circuits include interlayer insulators, passivation films, and resist materials for microlithography for LSI and ultra LSI materials.

Examples of the applications in the automobile and transport fields include materials for automobiles, such as lamp reflectors, bearing retainers, gear parts, corrosion-resistant coatings, switch parts, headlamps, inner parts of the engine, electrical parts, various interior and exterior parts, driving engines, brake-oil tanks, rust-proof steel plates for automobiles, interior panels, interior materials, protecting/binding wire harnesses, fuel hoses, automobile lamps, and glass substitutes. Other examples of the applications include multilayer glasses for railway vehicles. Further examples of the applications include materials for aircrafts, such as toughening agents for structural materials, peripheral members of the engine, protecting/binding wire harnesses, and corrosion-resistant coatings.

Examples of the applications in the architecture field include interior/processing materials, lamp covers, sheets, glass interlayer films, glass substitutes, and peripheral materials for solar cells. Examples thereof in the agricultural field include cover films for greenhouses.

Examples of the applications as next generation optical/electronic functional organic materials include next-generation DVDs; peripheral materials for organic EL elements; organic photorefractive elements; light-light conversion devices such as optical amplifiers and optical computing elements; substrate materials and fiber materials for the peripherals of organic solar cells; and encapsulants and adhesives for elements.

### EXAMPLES

The present invention is described in more detail, referring to examples which are not to be construed as limiting the present invention.

### (Viscosity of Composition)

The viscosity was measured by an E-type viscometer (product of TOKYO KEIKI INC.) at 23.0° C., using an END-type 48φ1-fold cone.

### (SiH Value)

The SiH value was measured by a 400 MHz NMR (product of Varian Technologies Japan, Ltd.). The SiH value of modified polyhedral polysiloxanes was determined by mixing the modified polyhedral polysiloxanes with dibromoethane, performing NMR analysis on the mixtures, and calculating the following equation (1).

SiH value (mol/kg)=[integration value of peak of SiH group of modified polyhedral polysiloxane]/[integration value of peak of methyl group of dibromoethane]×4×[weight of dibromoethane in mixture]/[molecular weight of dibromoethane]/[weight of modified polyhedral polysiloxane in mixture] (1)

### (Preparation of Samples for Heat Resistance Test and Light Resistance Test)

A polysiloxane composition (encapsulant) was charged into a mold and heat-cured in a convection oven for two hours at 80° C. followed by one hour at 100° C. and then five hours at 150° C. In this manner, a 2 mm-thick sample was prepared.

### (Heat Resistance Test)

Samples obtained in the manner described above were aged for 200 hours in a convection oven set at 150° C. (in air), and then visually observed. Samples with no color change (e.g. discoloration) were evaluated as “good”, and samples with color changes were evaluated as “bad”.

### (Light Resistance Test)

A metaling weather meter (model: M6T, product of Suga Test Instruments Co., Ltd.) was used. Samples obtained in the manner described above were exposed to radiation at a black panel temperature of 120° C. and an irradiance of 0.53 kW/m² until the total irradiance reached 50 MJ/m², and then visually observed. Samples with no color change (e.g. discoloration) were evaluated as “good”, and samples with color changes were evaluated as “bad”.

### (Preparation of Samples for Hot and Cold Impact Resistance Test)

Two single-crystal silicon chips with a size of 0.4 mm×0.4 mm×0.2 mm were bonded to an LED package (product of Enomoto Co., Ltd., product name: TOP LED 1-IN-1, external dimensions: 3528 (3.5 mm×2.8 mm×1.9 mm), inner diameter: 2.4 mm) with an epoxy adhesive (product name: Loctite 348, product of Henkel Japan Ltd.), and the resulting LED package was placed in a convection oven at 150° C. for 30 minutes so that the chips were fixed on the LED package. An encapsulant was injected into the resulting LED package, and then heat-cured in a convection oven for two hours at 80° C. followed by one hour at 100° C. and then five hours at 150° C. In this manner, a sample was prepared.

### (Hot and Cold Impact Resistance Test)

Samples obtained in the manner described above were subjected to 200 cycles of high temperature exposure at 100° C. for 30 minutes and low temperature exposure at −40° C. for 30 minutes with a thermal shock tester (product of Espec Corporation, TSA-71H-W), and then observed. Samples with no visible change through the test were evaluated as “good”, and samples with cracks, samples detached from the package, or discolored samples were evaluated as “bad”.

### (Preparation of Samples for Moisture Permeability Test)

The moisture permeability was measured for cured products as a measure of gas-barrier properties. Specifically, a lower moisture permeability corresponds to a higher level of gas-barrier properties.

An encapsulant was charged into a mold and heat-cured in a convection oven for two hours at 80° C. followed by one hour at 100° C. and then five hours at 150° C. In this manner, a sample (5 cm square, 2 mm thick) was obtained. This sample was aged for 24 hours at room temperature 25° C. at a humidity of 55% RH.

### (Moisture Permeability Test)

On a 5 cm-square glass plate (0.5 mm thick), a 5 cm-square polyisobutylene rubber sheet (3 mm thick, a square rim with a hollow square (3 cm square) in the inside) was fixed to prepare a jig. The hollow square was filled with 1 g of calcium chloride (for water content measurement, product of Wako Pure Chemical Industries, Ltd.). Further, a sample (5 cm square, 2 mm thick) obtained as above was fixed thereon to prepare a test sample. This test sample was aged in a constant temperature and humidity chamber (product of Espec Corporation, PR-2 KP) at 40° C. and a humidity of 90% RH for 24 hours. The moisture permeability (water vapor permeability) was calculated from the following equation (2).

Moisture permeability (g/m²/day)={(weight of entire test sample after moisture permeability test (g))−(weight of entire test sample before moisture permeability test (g))}×10000/9 (2)

### (Hydrogen Sulfide Test)

An encapsulant was injected into an LED package (product name: TOP LED 1-IN-1, product of Enomoto Co., Ltd.) and heat-cured in a convection oven for two hours at 80° C. followed by one hour at 100° C. and then five hours at 150° C. In this manner, a sample was prepared. This sample was placed in a flow gas corrosion tester (product of FactK Inc., KG130S) and subjected to a hydrogen sulfide exposure test for 96 hours under the conditions of 40° C., 80% RH, and 3 ppm of hydrogen sulfide. Samples were evaluated as “good” when no color change was observed on a reflector of the package, as “intermediate” when a slight color change was observed after the test, and as “bad” when color changes were observed.

### (Fluorescent Substance Settling Test)

To 5 g of an encapsulant was added 0.05 g of a fluorescent substance (product of Internatix, Y3957), and the mixture was stirred well and then left standing. After one hour, the mixture was observed and evaluated as “good” when the fluorescent substance remained dispersed, and as “bad” when the fluorescent substance settled.

### (Light Extraction Efficiency)

A 12 mil×13 mil square blue LED chip (product number: B1213AAA0 S46B/C-19/20, product of GeneLite Inc.), a gold wire, and a die-bond KER-3000 (product of Shin-Etsu Chemical Co., Ltd.) were mounted on an LED package (product name: TOP LED 1-IN-1, product of Enomoto Co., Ltd.). This LED was illuminated by applying electricity thereto with a total luminous flux measurement system (4) 300 mm) (product number: HM-0930, product of Otsuka Electronics Co., Ltd.) under the conditions: temperature=25° C.; current=30 mA; and interval=30 seconds, and measured for the total luminous flux. In total 100 samples were measured and averaged.

After the measurement, 0.1 g of an encapsulant was injected into each LED and heat-cured in a convection oven for two hours at 80° C. followed by one hour at 100° C. and then five hours at 150° C. Then, the encapsulated LEDs were illuminated by applying electricity thereto with the total luminous flux measurement system (φ 300 mm) (product number: HM-0930, product of Otsuka Electronics Co., Ltd.) under the conditions: temperature=25° C.; current=30 mA; and interval=30 seconds, and measured for the total luminous flux. All the 100 samples were measured and averaged.

The light extraction efficiency was calculated from the following equation.

Light extraction efficiency (%)=(total luminous flux of LED after encapsulation/total luminous flux of LED before encapsulation)×100

It should be noted that the total luminous fluxes before and after encapsulation are averages of the 100 samples.

Light extraction efficiencies (1) of 120% or higher were evaluated as “good”, light extraction efficiencies of 115% or higher but lower than 120% were evaluated as “intermediate”, and light efficiencies of lower than 115% were evaluated as “bad”.

### Production Example 1

Tetraethoxysilane (1083 g) was added to a 48% aqueous solution of choline (aqueous solution of trimethyl(2-hydroxyethyl)ammonium hydroxide, 1262 g), and the mixture was vigorously stirred at room temperature for two hours. When the reaction system generated heat and turned into a homogeneous solution, the stirring was slowed down and the solution was left to react for further 12 hours. Then, to a solid formed in the reaction system, methanol (1000 mL) was added to give a homogeneous solution.

The methanol solution was slowly added dropwise to a vigorously stirred solution of dimethylvinylchlorosilane (537 g), trimethylsilyl chloride (645 g), and hexane (1942 mL). After completion of the dropwise addition, the resulting mixture was left to react for one hour. Then, the organic layer was extracted and concentrated to a solid. The obtained solid was washed in methanol by vigorous stirring, and filtered to leave 592 g of a white solid of tris(vinyldimethylsiloxy)pentakis(trimethylsiloxy)-octasilsesquioxane (Fw=1166.2), which is an alkenyl group-containing polyhedral polysiloxane compound with 16 Si atoms and three vinyl groups.

### Example 1

A 10 g portion of the alkenyl group-containing polyhedral polysiloxane compound prepared in Production Example 1 was dissolved in toluene (20 g), and a xylene solution (0.8 μL) of platinum vinylsiloxane complex (platinum vinylsiloxane complex containing 3 wt % of platinum, product of Umicore Japan, Pt-VTSC-3X) was further dissolved in this solution. The resulting solution was added dropwise to a mixture solution of 1,3,5,7-tetrahydrogen-1,3,5,7-tetramethylcyclotetrasilozane (6 g) (the amount was determined such that the number of hydrosilyl groups is 3.8 per alkenyl group of the alkenyl group-containing polyhedral polysiloxane compound used) and toluene (20 g), and heated at 105° C. for two hours. The ¹H-NMR analysis of this solution confirmed that the alkenyl group of the alkenyl group-containing polyhedral polysiloxane compound disappeared. From this solution, toluene and unreacted components were evaporated, and then toluene (10 g) was added again to dissolve the reaction product. Separately, camphene (2.3 g) (the amount was determined such that the number of carbon-carbon double bonds is 0.17 per hydrosilyl group of 1,3,5,7-tetrahydrogen-1,3,5,7-tetramethylcyclotetrasiloxane used) was dissolved in toluene (10 g), and this solution was slowly added dropwise to the former solution and left to react at 105° C. for five hours. The ¹H-NMR analysis of the resulting solution confirmed that no peak of carbon-carbon double bond derived from camphene is present. The solution was cooled to room temperature, and then toluene therein was evaporated, leaving 17.5 g of a liquid modified polyhedral polysiloxane (SiH value: 2.82 mol/kg, viscosity at 20° C.: 19.4 Pa·s). To a 5.00 g portion of the obtained modified product was added 1,5-divinyl-3,3-diphenyl-1,1,5,5-tetramethyltrisiloxane (1.63 g), and the mixture was stirred to afford a polysiloxane composition. The composition thus obtained was evaluated by the above-mentioned methods. Table 1 shows the results.

### Example 2

A 10 g portion of the alkenyl group-containing polyhedral polysiloxane compound prepared in Production Example 1 and camphene (0.6 g) (the amount was determined such that the number of carbon-carbon double bonds is 0.26 per hydrosilyl group of 1,3,5,7-tetrahydrogen-1,3,5,7-tetramethylcyclotetrasiloxane used) were combined and dissolved by adding toluene (20 g). Then, a xylene solution (0.8 μL) of platinum vinylsiloxane complex (platinum vinylsiloxane complex containing 3 wt % of platinum, product of Umicore Japan, Pt-VTSC-3X) was further dissolved in this solution. The resulting solution was added dropwise to a mixture solution of 1,3,5,7-tetrahydrogen-1,3,5,7-tetramethylcyclotetrasiloxane (4.2 g) (the amount was determined such that the number of hydrosilyl groups is 2.7 per alkenyl group of the alkenyl group-containing polyhedral polysiloxane compound used) and toluene (20 g), and heated at 105° C. for three hours. The ¹H-NMR analysis of this solution confirmed that the alkenyl group of the alkenyl group-containing polyhedral polysiloxane compound and carbon-carbon double bond of camphene disappeared. The solution was cooled to room temperature, and then toluene therein was evaporated after addition of 1-ethynyl-1-cyclohexanol (1.06 μl) and dimethyl maleate (0.25 μl), leaving 13.0 g of a liquid modified polyhedral polysiloxane (SiH value: 2.23 mol/kg, viscosity at 20° C.: 26.8 Pa·s). To a 5.00 g portion of the obtained modified product was added 1,5-divinyl-3,3-diphenyl-1,1,5,5-tetramethyltrisiloxane (1.50 g), and the mixture was stirred to afford a polysiloxane composition. The composition thus obtained was evaluated by the above-mentioned methods. Table 1 shows the results.

### Example 3

Camphene (0.6 g) (the amount was determined such that the number of carbon-carbon double bonds is 0.26 per hydrosilyl group of 1,3,5,7-tetrahydrogen-1,3,5,7-tetramethylcyclotetrasiloxane used) was dissolved in toluene (5 g), and a xylene solution (0.6 μL) of platinum vinylsiloxane complex (platinum vinylsiloxane complex containing 3 wt % of platinum, product of Umicore Japan, Pt-VTSC-3X) was added thereto. The resulting solution was slowly added dropwise to a solution of 1,3,5,7-tetrahydrogen-1,3,5,7-tetramethylcyclotetrasiloxane (4.2 g) (the amount was determined such that the number of hydrosilyl is 2.7 per alkenyl group of the alkenyl group-containing polyhedral polysiloxane compound used) and toluene (4.2 g), and left to react at 105° C. for three hours. The ¹H-NMR analysis of the resulting solution confirmed that the alkenyl group of camphene disappeared. Separately, a 10 g portion of the alkenyl group-containing polyhedral polysiloxane compound prepared in Production Example 1 was dissolved in toluene (20 g), and this solution of the alkenyl group-containing polyhedral polysiloxane compound was slowly added dropwise to the former solution, and left to react at 105° C. for two hours. The ¹H-NMR analysis of the resulting solution confirmed that the alkenyl group of the alkenyl group-containing polyhedral polysiloxane compound disappeared. The solution was cooled to room temperature, and then toluene therein was evaporated after addition of 1-ethynyl-1-cyclohexanol (1.06 μl) and dimethyl maleate (0.25 μl), leaving 18.5 g of a liquid modified polyhedral polysiloxane (SiH value: 2.36 mol/kg, viscosity at 20° C.: 23.5 Pa·s). To a 5.00 g portion of the obtained modified product was added 1,5-divinyl-3,3-diphenyl-1,1,5,5-tetramethyltrisiloxane (1.58 g), and the mixture was stirred to afford a polysiloxane composition. The composition thus obtained was evaluated by the above-mentioned methods. Table 1 shows the results.

### Example 4

A 10 g portion of the alkenyl group-containing polyhedral polysiloxane compound prepared in Production Example 1 was dissolved in toluene (20 g), and a xylene solution (0.8 μL) of platinum vinylsiloxane complex (platinum vinylsiloxane complex containing 3 wt % of platinum, product of Umicore Japan, Pt-VTSC-3X) was further dissolved in this solution. The resulting solution was added dropwise to a mixture solution of 1,3,5,7-tetrahydrogen-1,3,5,7-tetramethylcyclotetrasiloxane (6 g) (the amount was determined such that the number of hydrosilyl groups is 3.8 per alkenyl group of the alkenyl group-containing polyhedral polysiloxane compound used), 1,1,3,3-tetramethyldisiloxane (0.6 g) (the amount was determined such that the number of hydrosilyl groups is 0.4 per alkenyl group of the alkenyl group-containing polyhedral polysiloxane compound used), and toluene (20 g), and heated at 105° C. for two hours. The ¹H-NMR analysis of this solution confirmed that the alkenyl group of the alkenyl group-containing polyhedral polysiloxane compound disappeared. From this solution, toluene and unreacted components were evaporated, and then toluene (10 g) was added again to dissolve the reaction product. Separately, camphene (2.3 g) (the amount was determined such that the number of carbon-carbon double bonds is 0.17 per hydrosilyl group of the 1,3,5,7-tetrahydrogen-1,3,5,7-tetramethylcyclotetrasiloxane used) was dissolved in toluene (10 g), and this solution was slowly added dropwise to the former solution and left to react at 105° C. for five hours. The ¹H-NMR analysis of this solution confirmed that no peak assigned to carbon-carbon double bond derived from camphene is present. The solution was cooled to room temperature, and then toluene therein was evaporated, leaving 17.1 g of a liquid modified polyhedral polysiloxane (SiH value: 2.55 mol/kg, viscosity at 20° C.: 20.2 Pa·s). To a 5.00 g portion of the obtained modified product was added 1,5-divinyl-3,3-diphenyl-1,1,5,5-tetramethyltrisiloxane (1.50 g), and the mixture was stirred to afford a polysiloxane composition. The composition thus obtained was evaluated by the above-mentioned methods. Table 1 shows the results.

### Example 5

A 10 g portion of the alkenyl group-containing polyhedral polysiloxane compound prepared in Production Example 1 and norbornene (0.4 g) (the amount was determined such that the number of carbon-carbon double bonds is 0.26 per hydrosilyl group of 1,3,5,7-tetrahydrogen-1,3,5,7-tetramethylcyclotetrasiloxane used) were combined and dissolved by adding toluene (20 g). Then, a xylene solution (0.8 μL) of platinum vinylsiloxane complex (platinum vinylsiloxane complex containing 3 wt° of platinum, product of Umicore Japan, Pt-VTSC-3X) was further dissolved in this solution. The resulting solution was added dropwise to a mixture solution of 1,3,5,7-tetrahydrogen-1,3,5,7-tetramethylcyclotetrasiloxane (4.2 g) (the amount was determined such that the number of hydrosilyl groups is 2.7 per alkenyl group of the alkenyl group-containing polyhedral polysiloxane compound used) and toluene (20 g), and heated at 105° C. for three hours. The ¹H-NMR analysis of this solution confirmed that the alkenyl group of the alkenyl group-containing polyhedral polysiloxane compound and carbon-carbon double bond of norbornene disappeared. The solution was cooled to room temperature, and then toluene therein was evaporated after addition of 1-ethynyl-1-cyclohexanol (1.06 μl) and dimethyl maleate (0.25 μl), leaving 13.0 g of a liquid modified polyhedral polysiloxane (SiH value: 2.19 mol/kg, viscosity at 20° C.: 27.2 Pa·s). To a 5.00 g portion of the obtained modified product was added 1,5-divinyl-3,3-diphenyl-1,1,5,5-tetramethyltrisiloxane (1.44 g), and the mixture was stirred to afford a polysiloxane composition. The composition thus obtained was evaluated by the above-mentioned methods. Table 1 shows the results.

### Example 6

To a 5.00 g portion of the liquid modified polyhedral polysiloxane (SiH value: 2.35 mol/kg, viscosity at 20° C.: 26.8 Pa·s) prepared in Example 2 were added 1,5-divinyl-3,3-diphenyl-1,1,5,5-tetramethyltrisiloxane (1.50 g) and then 3-glycidoxypropyltrimethoxysilane (0.16 g), and the mixture was stirred to afford a polysiloxane composition. The composition thus obtained was evaluated by the above-mentioned methods. Table 1 shows the results.

### Comparative Example 1

A xylene solution (0.8 μL) of platinum vinylsiloxane complex (platinum vinylsiloxane complex containing 3 wt % of platinum, product of Umicore Japan, Pt-VTSC-3X) was further dissolved in a solution of the alkenyl group-containing polyhedral polysiloxane compound (10 g) prepared in Production Example 1 and toluene (20 g). The resulting solution was slowly added dropwise to a solution of 1,3,5,7-tetrahydrogen-1,3,5,7-tetramethylcyclotetrasiloxane (20 g) (the amount was determined such that the number of hydrosilyl groups is 12.7 per alkenyl group of the alkenyl group-containing polyhedral polysiloxane compound used) and toluene (10 g), and left to react at 105° C. for two hours. The ¹H-NMR analysis of this solution confirmed that the alkenyl group of the alkenyl group-containing polyhedral polysiloxane compound disappeared. Toluene and unreacted components therein were evaporated after addition of 1-ethynyl-1-cyclohexanol (1.06 μl) and dimethyl maleate (0.25 μl), leaving 16.5 g of a liquid modified product (SiH value: 4.72 mol/kg, viscosity at 20° C.: 2.8 Pa·s). To a 5.0 g portion of the obtained modified product was added 3.1 g of 1,5-divinyl-3,3-diphenyl-1,1,5,5-tetramethyltrisiloxane, and the mixture was stirred to afford a composition. The composition thus obtained was evaluated by the above-mentioned methods. Table 1 shows the results.

### Comparative Example 2

A xylene solution (0.8 μL) of platinum vinylsiloxane complex (platinum vinylsiloxane complex containing 3 wt % of platinum, product of Umicore Japan, Pt-VTSC-3X) was further dissolved in a solution of the alkenyl group-containing polyhedral polysiloxane compound (10 g) prepared in Production Example 1 and toluene (20 g). The resulting solution was slowly added dropwise to a solution of 1,3,5,7-tetrahydrogen-1,3,5,7-tetramethylcyclotetrasiloxane (20 g) (the amount was determined such that the number of hydrosilyl groups is 12.7 per alkenyl group of the alkenyl group-containing polyhedral polysiloxane compound used) and toluene (10 g), and left to react at 105° C. for two hours. The ¹H-NMR analysis of this solution confirmed that the alkenyl group of the alkenyl group-containing polyhedral polysiloxane compound disappeared. Toluene and unreacted components therein were evaporated after addition of 1-ethynyl-1-cyclohexanol (1.06 μl) and dimethyl maleate (0.25 μl), leaving 16.5 g of a liquid modified product (SiH value: 4.72 mol/kg, viscosity at 20° C.: 2.8 Pa·s). To a 5.0 g portion of the obtained modified product were added 1,5-divinyl-3,3-diphenyl-1,1,5,5-tetramethyitrisiloxane (3.1 g) and vinyldiphenylmethylsilane (1.3 g), and the mixture was stirred to afford a composition. The composition thus obtained was evaluated by the above-mentioned methods. Table 1 shows the results.

### Comparative Example 3

In a solution of the alkenyl group-containing polyhedral polysiloxane compound (10 g) prepared in Production Example 1 and toluene (20 g), a xylene solution (0.8 μL) of platinum vinylsiloxane complex (platinum vinylsiloxane complex containing 3 wt % of platinum, product of Umicore Japan, Pt-VTSC-3X) was further dissolved. The resulting solution was slowly added dropwise to a solution of 1,3,5,7-tetrahydrogen-1,3,5,7-tetramethylcyclotetrasiloxane (20 g) (the amount was determined such that the number of hydrosilyl groups is 12.7 per alkenyl group of the alkenyl group-containing polyhedral polysiloxane compound used) and toluene (10 g), and left to react at 105° C. for two hours. The ¹H-NMR analysis of this solution confirmed that the alkenyl group of the alkenyl group-containing polyhedral polysiloxane compound disappeared. Toluene and unreacted components therein were evaporated after addition of 1-ethynyl-1-cyclohexanol (1.06 μl) and dimethyl maleate (0.25 μl), leaving 16.5 g of a liquid modified product (SiH value: 4.72 moi/kg, viscosity at 20° C.: 2.8 Pa·s). To a 5.0 g portion of the obtained modified product was added vinyl group-terminated straight-chain polydimethylsiloxane (6.0 g) (MVD8MV, product of Clariant K. K.), and the mixture was stirred to afford a composition. The composition thus obtained was evaluated by the above-mentioned methods. Table 1 shows the results.

TABLE 1

| | Heat | Light | Hot and cold | Moisture | | | Fluorescent | Light |
|---|---|---|---|---|---|---|---|---|
| | resistance | resistance | impact resistance | permeability | H₂S | Viscosity | substance | extraction |
| Example | test | test | test | (g/m² · 24 h) | test | (Pa · s) | settling test | efficiency (%) |
| Example 1 | Good | Good | Good | 9 | Good | 2.0 | Good | Good |
| Example 2 | Good | Good | Good | 8 | Good | 2.9 | Good | Good |
| Example 3 | Good | Good | Good | 10 | Good | 2.6 | Good | Good |
| Example 4 | Good | Good | Good | 17 | Intermediate | 2.1 | Good | Good |
| Example 5 | Good | Good | Good | 12 | Good | 3.1 | Good | Good |
| Example 6 | Good | Good | Good | 13 | Good | 2.4 | Good | Good |
| Comparative | Good | Good | Bad | 14 | Good | 0.06 | Bad | Intermediate |
| Example 1 | | | | | | | | |
| Comparative | Good | Good | Good | 12 | Good | 0.05 | Bad | Intermediate |
| Example 2 | | | | | | | | |
| Comparative | Good | Good | Good | 39 | Bad | 0.02 | Bad | Intermediate |
| Example 3 | | | | | | | | |

As seen in Table 1, the polysiloxane compositions obtained from the modified polyhedral polysiloxanes of the present invention were excellent in heat resistance, light resistance, hot and cold impact resistance, gas-barrier properties, and light extraction efficiency, and additionally had a viscosity that ensures good handleability for encapsulating an optical semiconductor device.

1. A modified polyhedral polysiloxane obtained by hydrosilylation of an alkenyl group-containing polyhedral polysiloxane compound (a), a hydrosilyl group-containing compound (b), and a cyclic olefin compound (c) having one carbon-carbon double bond in its molecule.

2. The modified polyhedral polysiloxane according to claim 1,
wherein the cyclic olefin compound (c) has a weight average molecular weight of less than 1000.

3. The modified polyhedral polysiloxane according to claim 1,
which is in a liquid form at 20° C.

4. The modified polyhedral polysiloxane according to claim 1,
wherein the hydrosilyl group-containing compound (b) is a cyclic siloxane having a hydrosilyl group and/or a straight-chain siloxane having a hydrosilyl group.

5. The modified polyhedral polysiloxane according to claim 1,
wherein the alkenyl group-containing polyhedral polysiloxane compound (a) comprises siloxane units represented by the formula:
[AR¹₂SiO—SiO_{3/2}]ₐ[R²₃SiO—SiO_{3/2}]_{b}
wherein a+b is an integer of 6 to 24, provided that a is an integer of 1 or larger, and b is an integer of 0 or 1 or larger; A is alkenyl; R¹ is alkyl or aryl; R² is hydrogen, alkyl, aryl or a group bonded to another polyhedral polysiloxane.

6. The modified polyhedral polysiloxane according to claim
comprising siloxane units represented by the formula:
[XR³₂SiO—SiO_{3/2}]ₐ[R⁴₃SiO—SiO_{3/2}]_{b}
wherein a+b is an integer of 6 to 24, provided that a is an integer of 1 or larger, and b is an integer of 0 or 1 or larger; R³ is alkyl or aryl; R⁴ is alkenyl, hydrogen, alkyl, aryl, or a group bonded to another polyhedral polysiloxane; and X is represented by the following formula (1) or (2), and in the case where multiple Xs are present, the Xs represented by the formula (1) or (2) may be the same or different, or the Xs may include both a structure represented by the formula (1) and a structure represented by the formula (2): 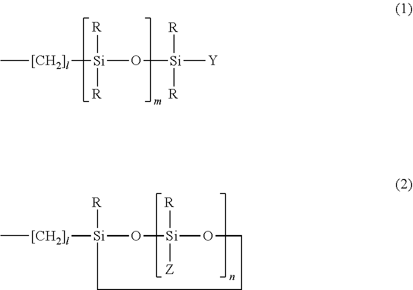
wherein l is an integer of 2 or larger; m is an integer of 0 or larger; n is an integer of 2 or larger; Y is hydrogen, alkenyl, alkyl, aryl, or a moiety bonded to a polyhedral polysiloxane via an alkylene chain, and Ys may be the same or different from one another; Z is hydrogen, alkenyl, alkyl, aryl, or a moiety bonded to a polyhedral polysiloxane via an alkylene chain, and Zs may be the same or different from one another; at least one of Ys and Zs is hydrogen, and at least one of Ys and Zs has a structure represented by the formula (3):
[CH₂]ₗ—R⁵ (3)
wherein 1 is an integer of 0 or larger, and R⁵ is a group containing a cyclic structure having a carbon skeleton; and
R is alkyl or aryl.

7. A polysiloxane composition comprising the modified polyhedral polysiloxane according to claim 1.

8. The polysiloxane composition according to claim 7,
further comprising a polysiloxane having at least two alkenyl groups in its molecule.

9. The polysiloxane composition according to claim 8,
wherein the polysiloxane having at least two alkenyl groups in its molecule has at least one aryl group.

10. The polysiloxane composition according to claim 7,
which has a viscosity as measured at 23° C. of not less than 1 Pa·s.

11. The polysiloxane composition according to claim 7, further comprising a hydrosilylation catalyst.

12. The polysiloxane composition according to claim 7, further comprising a curing retardant.

13. A cured product obtained by curing the polysiloxane composition according to claim 7.

14. An encapsulant comprising the polysiloxane composition according to claim 7.

15. The encapsulant according to claim 14,
wherein the encapsulant is an encapsulant for optical materials.

16. The encapsulant according to claim 14,
wherein the encapsulant is an encapsulant for high-brightness LEDs.

17. An optical device comprising the encapsulant according to claim 14.
